(19) United States
(12) Patent Application Publication
(10) Pub. No.: US 2007/0062290 A1
(43) Pub. Date: Mar. 22, 2007

(54) Motor driven mechanism for mechanically scanned ultrasound transducers

(75) Inventors: Yongrae Roh, Daegu (KR); Sanghan Lee, Daegu (KR); Ohbum Kwon, Daegu (KR); Susung Lee, Daegu (KR); Kookjin Kang, Daegu (KR); Jeongdong Woo, Daegu (KR); Hyungkeun Lee, Daegu (KR); Jooheon Seon, Kyungnam (KR)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Ultrasonic Technologies Ltd.

(21) Appl. No.: 11/217,052

(22) Filed: Aug. 30, 2005

(51) Int. Cl. G01N 29/04

(52) U.S. Cl. 73/634

(57) ABSTRACT

Drive mechanisms are provided for a mechanically scanned ultrasound transducer or wobbler. The size, weight, and shape of a wobbler transducer are more optimized by positioning a drive shaft of a motor orthogonal to an array rather than parallel with the array. Different devices may be used for transferring the force of the rotational movement of the motor to the array. A linear bushing transfers rotation motion of an arm connected with a motor to rotational motion of an arm connected with an array in one such device. In another device, a cam transfers rotational motion of the motor to rotational motion of the array.

### BACKGROUND

The present invention relates to a drive mechanism for mechanically scanned ultrasound transducers.

Three- or four-dimensional ultrasonic images may assist in diagnosis. A three-dimensional volume is scanned electronically using a two- or a one-dimensional array electrically scanned along one dimension and mechanically scanned along another dimension. Arrays mechanically scanned along one dimension may be wobbler arrays. A one-dimensional array is modified to be connected with a motor or other driving mechanism for mechanically scanning.

FIG. 1 shows one example of a known wobbler transducer 20. A linear array 22 is connected with a motor 26 by an arm 24. The motor 26 includes a drive shaft for driving reduction gearing 28. The reduction gearing connects with the arm 24 at a center of rotation 30. The rotational radius from the center 30 to the transducer array 22 should be large for linear or planar mechanical scanning. The large radius requires a large torque to move the array. To generate the large torque, a higher power motor is used. The reduction gearing 28 also assists in conversion of velocity to torque. The reduction gearing 28 acts to slow movement of the transducer 22 to allow for a dense scan of a patient. The drive shaft of the motor 26 is positioned generally parallel with the array 22, resulting in an inconvenient positioning of the motor for handheld use by the user. The bulky motor and rigid metal frame for supporting the motor increase the weight. The size and weight result in a transducer probe that is inconvenient for gripping.

In another example shown in FIG. 2, a motor 26 rotates a pulley 34. The pulley 34 rotates a belt 32. The belt 32 rotates an additional pulley 34 and shaft. Yet another pulley 36 on the shaft rotates a 1D convex array 22 through a wire belt 38. The drive shaft, shaft and array 22 are all generally parallel. The pulleys 34, 36 require alignment, leading to difficulty in tolerance management and manufacture. A large torque is used due to reduction rate in velocity by the pulleys 34, 36. Thus, a large motor 26 should be used, thereby increasing the size and weight. Degradation in efficiency and heat generation in the motor 26 may occur during a long-term operation. The mechanical driving part may increase the total size and weight of the transducer. Due to wear and breakage, the driving parts may fail from repetitive uses.

### BRIEF SUMMARY

By way of introduction, the preferred embodiments described below include drive mechanisms for a mechanically scanned ultrasound transducer. The size, weight, and shape of a wobbler transducer are more optimized by positioning a drive shaft of a motor orthogonal to an array rather than parallel with the array. The drive shaft may be more perpendicular than parallel to the direction of the transducer movement as well. Different devices may be used for transferring the force of the rotational movement of the motor to the array. A linear bushing is used to transfer rotation motion of an arm connected with a motor to rotational motion of an arm connected with an array in one embodiment. In other embodiments, a cam is used to transfer rotational motion of the motor to rotational motion of the array.

In a first aspect, a drive mechanism is provided for a mechanically scanned ultrasound transducer. An array of elements is moveable substantially perpendicular to the array. A bushing is on a shaft. A first arm connects with the array and is positioned slideably in the bushing. A second arm connects with a drive shaft of a motor and is positioned slideably in the bushing.

In a second aspect, a drive mechanism is provided for a mechanically scanned ultrasound transducer. An array of elements is moveable substantially perpendicular to the array. A cam connects between a motor and the array. The cam transfers motion of a drive shaft of the motor to motion of the array.

The present invention is defined by the following claims, and nothing in this section should be taken as a limitation on those claims. Further aspects and advantages of the invention are discussed below in conjunction with the preferred embodiments and may be later claimed independently or in combination. Different embodiments of the present invention may or may not achieve any of the various advantages discussed herein.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a side view of a prior art wobbler transducer;

FIGS. 2A and B are front and side views of a prior art wobbler transducer.

FIGS. 3A and B are front and side views of a drive mechanism with a linear bushing in one embodiment;

FIG. 4 is a partial view of the drive mechanism of FIGS. 3A and B;

FIGS. 5A, B and C show motion relationships between the components of the drive mechanism of FIGS. 3A and B;

FIG. 6 is a cut away view of an array for mechanical scanning with array guides;

FIGS. 7A and B are front and side views of a drive mechanism with a cam in one embodiment;

FIG. 8 is a partial view of the drive mechanism of FIGS. 7A and B;

FIGS. 9 and 10 show motion relationships between the components of the drive mechanism of FIGS. 7A and B;

FIGS. 11A and B are front and side views of a drive mechanism with a cam in another embodiment; and

FIG. 12 is a partial view of the drive mechanism of FIGS. 11A and B.

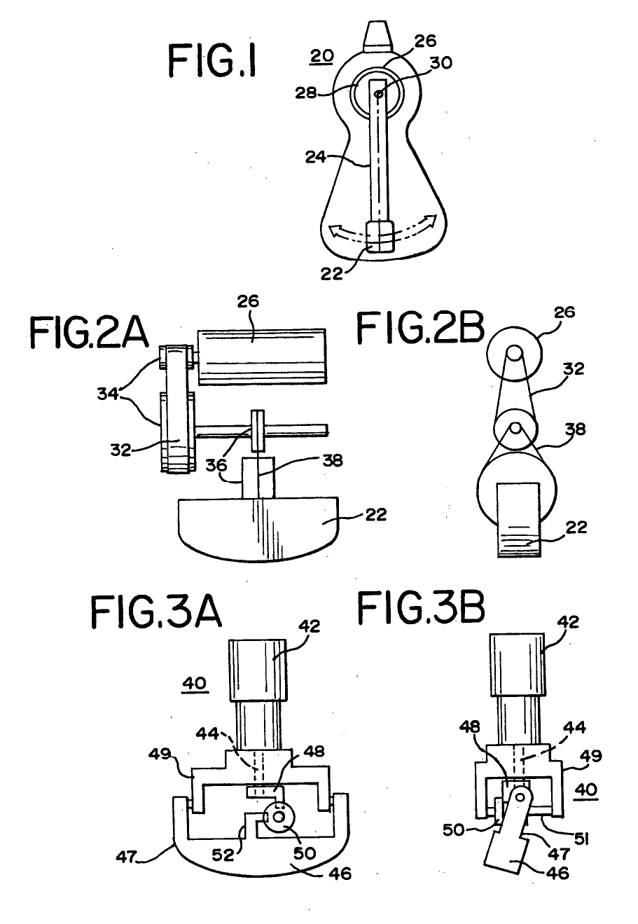

### DETAILED DESCRIPTION OF THE DRAWINGS AND PRESENTLY PREFERRED EMBODIMENTS

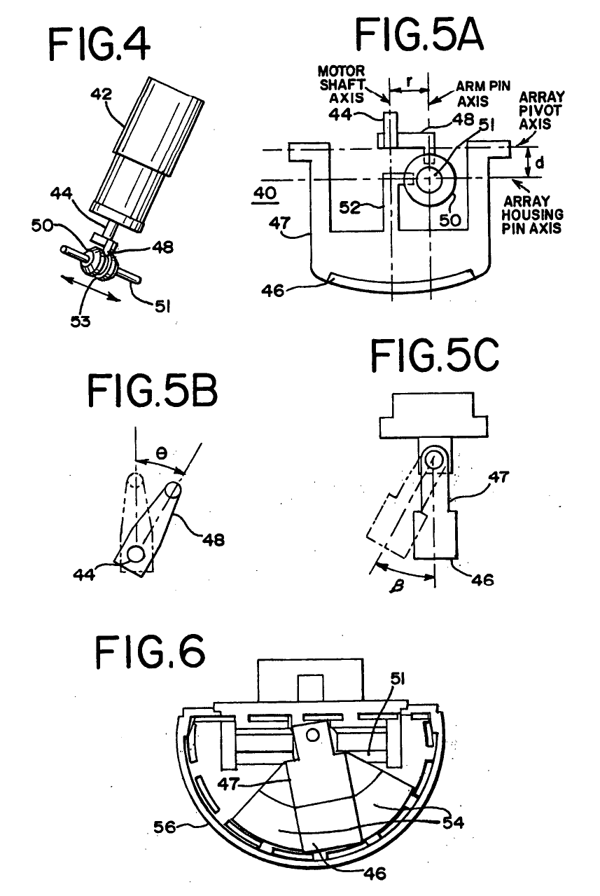

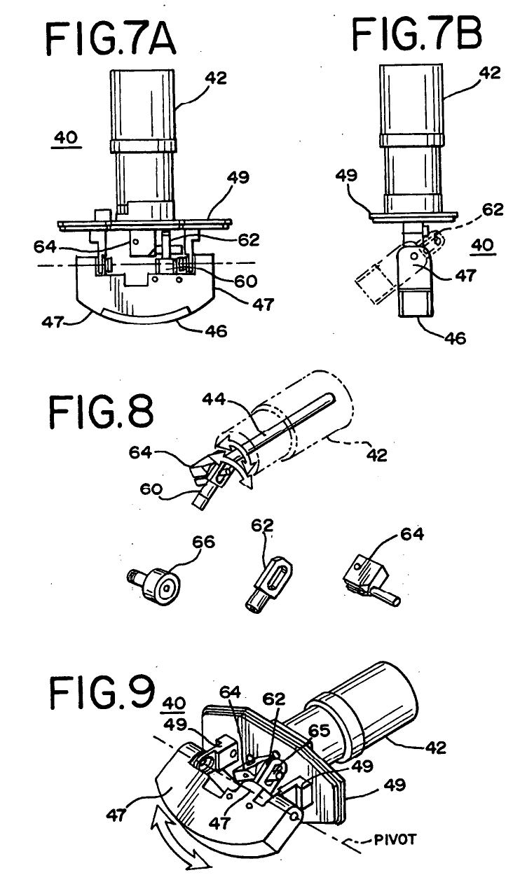

Several embodiments of drive mechanisms 40 for wobbler arrays have simple kinetic power transmission, providing a small and light weight wobbler. The transducer handle may be ergonomically designed for easier grip. FIGS. 3-6 show one embodiment using a linear bushing. FIGS. 7-10 show one embodiment using a cam. FIGS. 11 and 12 show another embodiment using a cam. Other embodiments may be provided. The wobbler arrays of any of the embodiments are used, for example, for volume scanning of abdominal regions by rotating a convex-type 1D array. The driving mechanism 40 can precisely and rapidly move a 1D array for obtaining clear real-time ultrasonic images.

Components and arrangements of components common to all of the embodiments are discussed in general prior to discussing the components specific to each of the different embodiments. Each of the drive mechanisms 40 are associated with a motor 42 and associated drive shaft 44 positioned more perpendicular than parallel to an array of elements 46, the direction of mechanical movement of the array 46 and/or a surface of an effective array (i.e. the surface defined by the azimuth extent of the array and the elevational displacement of the array). Other motor 42 positions, such as more parallel, may be used.

The array 46 of elements is an array of two or more piezoelectric, capacitive membrane, microelectromechanical, combinations thereof or other elements operable to transduce between acoustical and electrical energies. In one embodiment, the array 46 is a one-dimensional linear, curved linear, convex or concave array of elements. The elements extend in a single row along an azimuth dimension. In other embodiments, a 1.25, 1.5, 1.75 or 2-dimensional array of elements is provided. The array 46 may also include additional components, such as matching layers, backing block and/or electrodes.

The array 46 is moveable substantially along a surface. Substantially along is used to account for manufacturing tolerance based deviations from the desired surface. The surface is any of a curved surface, a flat plane or combinations thereof. The array 46 extends along one dimension of the surface, such as along the azimuth dimension of the array 46. The other dimension of the surface is defined by the path of movement of the transducer array 46. Using a one-dimensional array, the array 46 is moveable substantially along an elevation dimension generally perpendicular to the azimuth dimension. Alternatively, the array 46 is moved mechanically along the azimuth dimension or along any vector in a volume.

The array 46 is used to electronically scan along the azimuth dimension and mechanically scan along the elevation or other dimension. By scanning within a volume, a three-dimensional image may be generated. The repetitive rotational or linear movement of the one-dimensional array 46 may allow for four-dimensional imaging, three-dimensional imaging as a function of time.

The array 46 is positioned in a housing 47. The housing 47 is plastic, metal, wood, fiberglass, resin or other now known or later developed material. The housing 47 includes one or more arms rotatably connected with a frame 49. The rotatable connection is a pin and hole with or without bearings. An axis of rotation is provided spaced away from the array 46 by the arms. The array 46 is substantially parallel with the axis of rotation, rotating about the axis in response to force transferred by the drive mechanism from the motor 42.

The motor 42 is a stepper motor which can control the angle of rotations of the drive shaft 44. Alternatively, the motor 42 is a magnetic, hydraulic, electric or other motor operational to generate rotational motion. The motor 42 is operable to provide 9.8 oz-in torque, but a greater or lesser torque may be provided. Given the general longitudinal shape of the motors, the reduced torque, and the positioning of the motor 42 discussed above, a housing may be formed around the drive mechanism 40 with a convenient size, shape and weight for gripping by a user. In one embodiment, the motor 42 has a length of about 54.5 mm without the drive shaft 44 and a diameter of about 25 mm, but larger or smaller sized motors may be used. The vertical positioning of the motor 42 more likely allows for a grip that is easily held by a user's hand that extends around the motor 42.

The drive shaft 44 is a metal rod, a rod of other materials, other structure for imparting rotational or longitudinal motion, combinations thereof or other now known or later developed drive shafts of a motor 42. The motor 42 and the associated drive shaft 44 are positioned to be more perpendicular than parallel to the surface of movement of the array 46. By activation of the motor 42, the drive shaft 44 rotates in the embodiments shown in the Figures. The drive shaft 44 is connected with the array 46 of elements and the motor 42 to move the array 46 of elements. The connection is indirect or direct. For example, the drive shaft 44 directly connects with the motor 42 and indirectly connects with the array 46. Rotation of the drive shaft 44 is operable to move the array 46. The relative positioning of the drive shaft 44 and motor 42 to the array 46 may allow for the drive mechanism to be free of a reduction gear and/or pulleys and belts. In alternative embodiments, a reduction gear or pulley and belt are provided. In yet other alternative embodiments, the motor 42 and/or the drive shaft 44 are positioned more parallel than perpendicular to the one- or two-dimensional surface formed by movement of the array 46.

The frame 49 is metallic, wood, fiberglass, plastic, combinations thereof or other now known or later developed materials. The frame 49 is formed as a one piece construction or from connecting together with glue, screws, bolts, combinations thereof or other connectors of multiple pieces. The frame 49 connects with the various components of the drive mechanism 40 for maintaining the relative positioning of the components.

FIG. 6 shows optional array guides 54 for use in any of the embodiments. The array guides 54 are attached at one or both sides of the array 42. The array guides 54 are solid plastic or other light but stiff material. For example, high impact ABS is used. Since the driving mechanism 40 is placed in a space between the frame 49 and a convex-type array 42, the amount of oil to fill the empty space between a cap 56 and the array 42 is reduced, reducing the overall weight of the transducer. The array guide 54 may be shaped to reduce creating of bubbles in the oil during operation, such as being angled to lower friction. Since the array guides 54 occupy additional volume, the overall weight may be reduced by a reduction in fill oil. The array guides 54 may also protect the array 42 from an impact applied to the cap 56. A seal, seal washer and/or other component prevent leakage around the drive shaft 44.

FIGS. 3-6 show one embodiment of a wobbler transducer for three- or four-dimensional ultrasound imaging. The wobbler transducer uses the drive mechanism 40 for mechanically scanning or moving the array 46 along at least one dimension. The drive mechanism 40 includes the motor 42 or the combination of the motor 42 and associated drive shaft 44 oriented more perpendicular than parallel with the surface defined by the azimuth extent of the array 46 and the mechanical movement in the elevation dimension or other angle of the array 46. The drive mechanism also includes a rotating arm 48, one or more shafts 51, a bushing 50, a rocking arm 52, the array 46, the array housing 47, the motor 42, the drive shaft 44, and the frame 50. Additional, different or fewer devices may be provided, such providing the array 46 with direct connection to the rocking arm 52 and without the array housing 47.

The rotating arm 48 connects with the drive shaft 44. The rotating arm 48 is metallic, plastic or other material for transmitting movement of the drive shaft 44 to the array 46. The connection is indirect or direct. For example, the rotating arm 48 connects with the motor 42 through the drive shaft 44 and connects with the array 46 of elements through the bushing 50. The connection with the drive shaft 44 is a fixed connection, such as associated with bonding, a pressed fit, bolts, set screws, screws, latches, shaped tongue and groove, shaped shaft and hole, combinations thereof or other now known or later developed technique for preventing movement of the rotating arm 48 different than or separate from the drive shaft 44 in at least one direction. The arm 48 has a length less than an azimuth extent of the array 46. For example, the arm 48 is less than half a length of the array 46. Greater or lesser length of the arm 80 or the array 46 may be used.

The rotating arm 48 includes a pin positioned slideably in the bushing 50. The pin extends into a groove 53 on the bushing 50. The pin of the rotating arm 48 extends substantially perpendicular to the shaft 51 from the bushing 50 and substantially parallel with the drive shaft 44. The pin portion of the rotating arm is formed with another portion connected with the drive shaft 44. The other portion connects substantially perpendicular to the drive shaft 44. The pin at the end of the rotating arm 48 is at a right angle to the arm 48 for interacting with the bushing 50. As the rotating arm 48 rotates with the drive shaft 44, the pin within the groove 53 slides and rotates within the groove 53. The change in position of the arm 48 causes the bushing 50 to move along the shaft 5 1. The arm 48 moves in a circle, such as over a 90° range. The arm 48 rotates in a plane substantially parallel to the surface of movement of the array 46 and/or parallel with the shaft 51.

The shaft 51 is a metal rod, but plastic or other materials may be used. The shaft 51 is positioned within the frame 49 to guide movement of the bushing 50 in response to rotation of the arm 48. The circular rotation of the arm 48 is transferred to a linear motion along the shaft 51. As the arm 48 moves back and forth over about a 90° or less range of rotation, the bushing 84 moves back and forth along the shaft 51. The shaft 51 and bushing 50 are an only shaft and bushing used. In alternatively embodiments, a plurality of shafts 51 and associated bushings are used.

The bushing 50 is a linear bushing, such as a bushing having a ball or a plurality of balls for rolling along the shaft 51. As an alternative to balls, other reduced or low friction structures may be provided for sliding along the shaft 51, such as a greased or oiled metal-to-metal contact, or Teflon coating. In response to the force from the arm 48 and the motor 42, the bushing 50 is slid along the shaft 51. The array 46 is moved in response to or based on movement of the bushing 50.

The bushing 50 includes the groove 53. The groove 53 extends around only a portion of the bushing 50, such as around a quarter or half of the circumference. In one embodiment, the groove 53 extends around the entire circumference of the bushing 50. The same or separate grooves 53 are provided for the arms 48 and 52. The groove 53 is in a plane normal to the axis of the shaft 51, but may extend laterally or at other angles. In one embodiment, the linear bushing is about 10 mm in length and 7 mm in diameter with the groove 53 having 3 mm of width and depth, but other sizes for one or more dimensions are possible. The pin of the rotating arm 48 has a length and diameter of about 3 mm, but other sizes are possible.

The rotating arm 48 is positioned such that the pin is in the groove 53, but past the shaft 51 in a zero degree position of the drive shaft 44, and in the groove 53, but before the shaft 51 in a ±45 degree position of the drive shaft 44. The reciprocal rotation of the arm 48 pushes up and down the groove 53 of the linear bushing 50, causing a linear reciprocal movement of the linear bushing 50.

Also positioned in the groove 53, a different groove or an aperture on the bushing 50 is the rocking arm 52. The rocking arm 52 connects with the array 46, such as being part of the array housing 47 or other direct connection to the array 46 or array housing 47, but indirect connection may be used. The connection of the rocking arm 52 and/or a portion of the rocking arm 52 are substantially perpendicular to the array 46, such as extending away from the array 46 towards the axis of rotation of the array 46.

The rocking arm 52 is metallic, plastic or other material for transmitting movement of the bushing 50 to the array 46. The rocking arm 52 has a length shorter than a distance between the array 46 and the axis of rotation of the array 46, but may be longer. The rocking arm 52 is straight, such as extending from the array 46 to the bushing 50. Alternatively and as shown in FIGS. 3A and 5A, the rocking arm 52 includes a pin portion at an angle, such as 90 degree angle, for positioning within the groove 53 of the bushing 50.

The rocking arm 52 is positioned slideably in the bushing 50, such as being rotatable and/or linearly sliding relative to the bushing 50. For example, the pin portion extends into a groove 53 on the bushing 50. The pin portion of the rocking arm 52 extends substantially perpendicular to the shaft 51 from the bushing 50 and substantially parallel with the axis of rotation of the array 46. As the bushing 50 slides linearly, the portion of the rocking arm 52 in contact with the bushing 50 also moves linearly. Since the rocking arm 52 connects with the array 46 and the array 46 is limited in movement, the linear motion causes the array 46 to rotate. The rocking arm 52 may move up and down relative to the bushing 50 and shaft 51 as the array 46 rotates. The rocking arm 52 is within the groove 53, but at a position furthest from the motor 42, when the array 46 is at a zero degree position (i.e., in line with the axis of the drive shaft 44). The rocking arm 52 is within the groove 53, but at a position closest to the motor 42, when the array 46 is at a maximum offset position (i.e., rocked to either side). During reciprocal movement of the linear bushing 50, the array 46 rotates or wobbles.

FIGS. 5A, B and C show motion of the array 46 during operation. The drive shaft 44 rotates the rotating arm 48 about the drive shaft 44. The rotation of the rotating arm 48 transfers into linear motion of the bushing 50 along the shaft 5 1. The linear motion of the bushing 50 along the shaft 51 transfers into motion of the rocking arm 52. The motion of the rocking arm 52 transfers into rotational motion of the array 46. The rotational angle β of the array 46 is calculated according to Eq. 1:

$$β = {sin}^{- 1} ( \frac{r}{d} sin θ )$$

wherein r denotes the distance between the motor shaft 44 and pin of the rotating arm 48, d denotes the distance between the rotational center of the array 46 and the pin of the rocking arm 52, and θ denotes the rotational angle of the motor shaft 44. If r and d are made equal and the angular velocity of the motor 42 is constant over the angle (constant-velocity rotational movement), the angular velocity of the array is also constant as shown in Eq. 1. In one embodiment, r is 8 mm, d is 8 mm and θ is ±45 degrees (total of 90 degrees). The angle of rotation of the array 46 is the same as the angle of rotation of the drive shaft 44. Other distances and/or angles may be used.

FIGS. 7-12 show other embodiments of the drive mechanism 40. The drive mechanism 40 is used as a wobbler transducer for four- or three-dimensional ultrasound imaging. A cam 60 is provided in two different embodiments. The cam 60 connects between the motor 42 and the array 46 for transferring motion of the drive shaft 44 to the array 46.

In the embodiment shown in FIGS. 7-10, the drive mechanism 40 includes the motor 42, the drive shaft 44, the frame 49, the array 46, the array housing 47, an arm 64 with an arm pin 65, and a cam 60 with a slot 62 and cam follower 66. Additional, different or fewer components may be provided.

The arm 64 and arm pin 65 has a same or different construction and/or material as the rotating arm 48 of FIGS. 3-6. For example, the arm pin 65 and/or arm 64 are high-speed steel with heat treatment to reduce friction. In one embodiment, the arm 64 includes a sheath or box structure for locking to the drive shaft 44 with a pin, screw, bonding or other device or technique. The arm pin 65 extends perpendicularly or at another angle from the drive shaft 44. The arm pin 65 is part of one piece with the arm 64 or attaches to the arm 64. In one embodiment, the arm pin 65 is about 25 mm long and 3 mm in diameter, but shorter or longer distances may be provided. Alternatively, the arm pin 65 extends from a gear head connected with the motor 42.

The cam 60 includes two portions, a slot 62 and a cam follower 66. The slot 62 connects slideably with the arm pin 65. The slot 62 is made of plastic materials, such as acetate resin, but other non-plastic materials may be used. The slot 62 has a tuning fork shape, but other shapes with a closed or open slot 62 may be used. The slot 62 is a through aperture, but may be a groove. In one embodiment, the aperture of the slot 62 is 9 mm in length and 3 mm in width with a thickness of 3 mm, but other dimensions may be used. The internal surface of the aperture is flat, rounded or peaked.

The cam follower 66 rotatably connects with the slot 62. The cam follower 66 reduces friction by rolling-contact with the slot 62 through needles positioned between an outer ring and a threaded shaft. The cam follower 66 serves as a needle bearing in use for rotational movement. The slot 62 and the cam follower 66 are firmly mounted by double insert molding, but other mountings may be used. Alternatively, where threads in the shaft of a cam follower 66 are used as a male screw and the lower end of a slot 62 is machined into a female screw, the slot 62 is rigidly secured to the cam follower 66 using an adhesive for securing a shaft opening part. The cam follower 66 is made of metal, such as high speed steel, or other material.

The cam follower 66 connects with the array 46, such as being mounted fixedly in the array housing 47. The cam 60 is mounted such that the cam 60 extends generally perpendicular to the array 46 and generally parallel with the drive shaft 44 in one position. Other angles may be provided. The slot 62 is positioned with the arm pin 65 within, such as extending through, the slot 62.

In operation, the rotational force of the motor shaft 44 is transmitted to an arm 64 and causes reciprocal and circular movement of an arm pin 65 perpendicular to the drive shaft 44 of the motor 42 within a predetermined angular range. The arm pin 65 is mounted to the arm 64 and reciprocally rotates along with the rotation of the motor 42 while linearly moving or sliding in the slot 62 mounted to the cam follower 66, pushing the slot 62. The frame 49 is free of rotational shafts other than the drive shaft 44 of the motor 42, so that the frame does not require high rigidity. The frame 49 may be made of light weight high engineering plastic (PEEK) or other materials.

The reciprocal movement of the arm pin 65 pushes the slot 62, rotating the slot 62 within the cam follower 66. The array housing 49 or array 46 connects to the frame 49 with bearings and bolts or other structure in a pivotal axis. The driving force by a motor 42 is transferred to the cam follower 66 through the rotational and circular movement of the slot 62. The array 46, which is substantially perpendicular to the cam follower 66, rotates about the pivot axis in response to the force applied to the cam follower 66. The slot 62 and cam follower 62 also rotate relative to the pivot axis of the array 46 in response to the force applied to the cam follower 66 through the slot 62 by the arm pin 65.

The transfer of motion is summarized as follows: motor 42→rotational movement of drive shaft 44→rotational movement of arm pin 65→reciprocal and linear movement between arm pin 65 and slot 62→reciprocal and rotational movement of the cam follower 66 (rotational movement around an axis perpendicular to the pivotal axis)→reciprocal and rotational movement of the array 46 around the pivot axis.

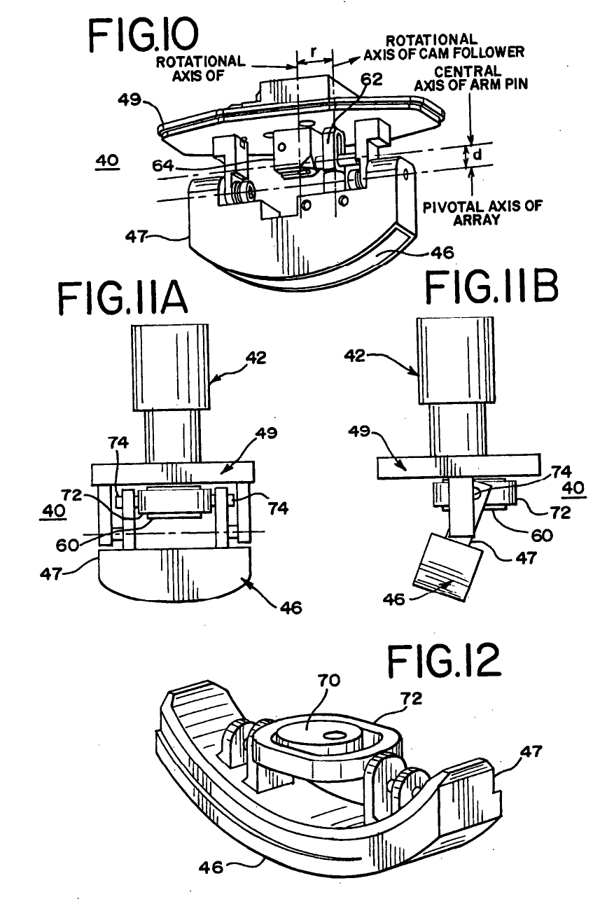

As shown in FIG. 10, the angle of reciprocal and rotational movement of the array 46, the resolution, and/or the velocity of the array, is controlled by appropriately adjusting the distance r between the rotational axis of the motor 42 and the rotational axis of the cam follower 66, and the distance d between the central axis of the arm pin 65 and the array pivot axis. For example, r and d distances are 8 mm and 5.9 mm, respectively, but other distances may be provided. For a maximum wobbling angle of the array 46 of 90 degrees, the maximum motor shaft rotational angle is −36.4 degrees to +36.4 degrees. Other rotational angles may be used. Where the rotational angle of the arm pin 65 by the motor 42 is θ and the rotational angle of the array 46 is φ, the rotational angle of the array 46 relative to the rotational angle of the motor 42 is obtained by the following equation:

$$ϕ ( θ , r , d ) = {tan}^{- 1} ( \frac{r}{d} tan θ ) \qquad Eq . 2$$

In the embodiment shown in FIGS. 11 and 12, the drive mechanism 40 includes the motor 42, the drive shaft 44, the frame 49, the array 46, the array housing 47 and the cam 60 with a follower 72. Additional, different or fewer components may be provided.

The cam 60 is metal, speed steel, plastic, wood, fiberglass or other material. As shown, the cam 60 is a circular disk, such as a cylinder with a 7.65 mm radius. Larger or smaller cams may be used. For transferring rotational to reciprocating motion, the circular disk connects off-center to the drive shaft 44, such as about 3.3 mm or other distance from the center. The connection is by pressure fit, bonding, screw, bolt, wedge or other mechanism. In another embodiment, the cam 60 is elliptical, oval, polygonal or other shape providing variation in distance from the drive shaft 44 as a function of position along the circumference. The cam 60 has a thickness sufficient to maintain contact with the follower 72 as the follower moves up and/or down due to rotation about an axis of array rotation.

The cam 60 converts a rotating motion into a reciprocating or back-and-forth motion. The rotational force of the drive shaft 44 is transmitted to the cam 60 and causes a reciprocal and circular movement of the cam 60 in any range of motion, such as a range of 180 degrees.

The follower 72 is metal, speed steel, plastic, wood, fiberglass or other material. The follower 72 is positioned adjacent to the cam 60, such as surrounding at least half a circumference of the cam 60. In one embodiment, the follower 72 surrounds the entire circumference of the cam 60. The aperture in the follower 72 for the cam 60 is generally rectangular, but other shapes may be used. The short dimension of the aperture is a same size or slightly larger that a maximum diameter of the cam 60. The long dimension of the aperture of the follower 72 is long enough to avoid blocking rotation of the cam 60. In the embodiment about with the circular cam 60 with a radius of 7.65 mm and center off-set of 3.3 mm, the aperture of the follower 72 is 15.3 mm by 18.8 mm, but other sizes may be provided. The follower 72 is of any desired thickness around the aperture, such as about 3 mm.

The follower 72 includes one or more pins 74. The pins 74 connect rotatably with the array 46, such as connecting with an arm on the array housing 47. The array 46 and/or array housing 47 connect rotatably with the frame 49 to form a pivot axis between the follower 72 and the array 46. As the array 46 rotates about the axis, the follower 72 slides substantially along a plane perpendicular with the drive shaft 44. The follower 72 also rotates about the axis with the array 46, but the rotatable connection with the arm of the array housing 47 allows the follower 72 to substantially maintain a level position relative to the cam 60.

In response to the reciprocal and circular movement of the cam 60, the follower 72 moves reciprocally and linearly. The sliding or linear movement of the pins of the follower 72 transfers motion to the array 46. The array housing 47 coupled to the pins of the follower 72 is subject to leverage movement relative to the pins of the follower 72, thereby moving reciprocally and circularly around an array pivot axis.

Since the rotational angle of the array movement may be small compared to the motor rotation, the driving mechanism 40 may operate as a reduction gear. For example, in order to obtain a 90 degree rotational movement of the array 46 in response to a 180 degree rotational movement of the motor 42, the reduction gear ratio may be set to 2:1 by modifying the distance between the pivot axis of the array rotation and the pins at both ends of the follower 72 and the largest distance between the shaft center and the circumference in the cam 60. As such, the reduction ratio can be adjusted to control the array rotation speed and scanning resolution.

Using the three different embodiments described above or other related embodiments, a step motor may be vertically positioned perpendicular to the direction of the array movement, i.e., in the direction of the grip. The driving parts may be in a small space in front of the vertically established motor, thereby reducing the size of the grip. This allows the handle to be more ergonomically designed. The driving parts are small, reducing the weight.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (we) claim:

1. A drive mechanism for a mechanically scanned ultrasound transducer, the drive mechanism comprising:
an array of elements moveable substantially perpendicular to the array; and
a shaft;
a bushing on the shaft;
a first arm connected with the array and positioned slideably in the bushing;
a motor having a drive shaft; and
a second arm connected with the drive shaft and positioned slideably in the bushing.

2. The drive mechanism of claim 1 wherein the shaft and bushing on the shaft are an only shaft and bushing transferring motion from the motor to the array.

3. The drive mechanism of claim 1 wherein the array of elements is a one-dimensional array of elements in a housing, the array having an axis of rotation spaced away from the array, and the first arm connected with the housing.

4. The drive mechanism of claim 1 wherein the bushing comprises a groove extending around at least a quarter a circumference of the bushing, the first and second arms positioned in the groove.

5. The drive mechanism of claim 4 wherein the groove extends around an entire circumference of the bushing.

6. The drive mechanism of claim 1 wherein the first arm extends substantially perpendicular to the shaft from the bushing and substantially parallel with an axis of rotation of the array.

7. The drive mechanism of claim 6 wherein the first arm connects with the array substantially perpendicular to the array, the array substantially parallel with the axis of rotation.

8. The drive mechanism of claim 1 wherein the second arm extends substantially perpendicular to the shaft from the bushing and substantially parallel with the drive shaft.

9. The drive mechanism of claim 8 wherein the second arm connects substantially perpendicular to the drive shaft.

10. The drive mechanism of claim 1 wherein the drive shaft is operable to rotate the second arm about the drive shaft, the rotation of the second arm transferred into linear motion of the bushing along the shaft, the linear motion of the bushing about the shaft transferred into motion of the first arm, the motion of the first arm transferred into rotational motion of the array.

11. The drive mechanism of claim 1 used in a wobbler transducer probe.

12. A drive mechanism for a mechanically scanned ultrasound transducer, the drive mechanism comprising:
an array of elements moveable substantially perpendicular to the array; and
a motor having a drive shaft; and
a cam connected between the motor and the array, the cam operable to transfer motion of the drive shaft to motion of the array.

13. The drive mechanism of claim 12 wherein the cam comprises a first portion connected with the array and a second portion rotatable within the first portion.

14. The drive mechanism of claim 13 wherein the second portion comprises a slot;
further comprising:
an arm connected with the drive shaft and extending into the slot.

15. The drive mechanism of claim 13 wherein the first portion connects with an array housing, the array housing connected with the array.

16. The drive mechanism of claim 13 wherein the array of elements is a one-dimensional array of elements in a housing, the housing having an axis of rotation spaced away from the array, and the cam extending generally perpendicular to the array.

17. The drive mechanism of claim 14 wherein the arm is operable to slide in the slot due to rotational motion from the drive shaft, the second portion is operable to rotate relative to the first portion in response to the rotational motion from the arm, and the first portion, second portion and array are operable to rotate about an axis in response to the rotational motion from the arm.

18. The drive mechanism of claim 12 wherein the cam connects with the drive shaft off-center.

19. The drive mechanism of claim 18 wherein the cam comprises a cylinder.

21. The drive mechanism of claim 18 further comprising a follower positioned adjacent to the cam.

22. The drive mechanism of claim 21 wherein the follower surrounds at least half a circumference of the cam, the follower slideable substantially along a plane perpendicular with the drive shaft.

23. The drive mechanism of claim 21 wherein the follower comprises at least one pin connected with the array.

24. The drive mechanism of claim 23 wherein the array is rotatable about an axis, the axis being between the at least one pin and the array.

25. The drive mechanism of claim 23 wherein the cam rotates in response to the drive shaft, the follower slides in response to the rotation of the cam, the pin moves with the follower, an arm connecting the array to the pin rotates about the axis in response to the pin moving, and the array rotates about the axis in response to the pin moving.
